(19) United States
(12) Patent Application Publication
(10) Pub. No.: US 2024/0418421 A1
(43) Pub. Date: Dec. 19, 2024

(54) Separator device, compressor with a separator device, and refrigeration system with a separator device

(71) Applicant: BITZER KÜHLMASCHINENBAU GMBH, Sindelfingen (DE)

(72) Inventors: Jonas BAUKNECHT, Böblingen (DE); Steffen SECKER, Böblingen (DE)

(21) Appl. No.: 18/704,762

(22) PCT Filed: Oct. 26, 2022
(86) PCT No.: PCT/EP2022/079934

§ 371 Date: Apr. 25, 2024

(30) Foreign Application Priority Data
Oct. 26, 2021 (DE) 10 2021 127 757.4

(51) Int. Cl. F25B 43/02; B01D 45/16; B04C 3/00; B04C 3/06

(52) U.S. Cl. CPC F25B 43/02; B01D 45/16; B04C 3/06; B04C 2003/006; F25B 2400/23

(57) ABSTRACT

A separator device separates a liquid phase of a second medium, in particular a lubricating medium, from a mixture having a gaseous phase of a first medium, in particular a refrigerant. The separator device includes: a housing which forms a cyclone chamber arranged along a central axis and has an upper end region and a lower end region on opposite sides with respect to the central axis; an immersion tube; and flow guiding means for forming a helical flow in the cyclone chamber around the central axis. An inlet into the cyclone chamber for the mixture of the first and second medium is provided in the upper end region and a first outlet for the first medium and a second outlet for the separated second medium is provided in the lower end region. The immersion tube projects from the lower end region in the central axis into the cyclone chamber.

The present invention relates to a separator device, in particular a lubricant separator device, for separating a liquid phase, in particular a lubricant, from a mixture having a gaseous phase, in particular of a refrigerating medium, of at least one medium, to a compressor, in particular a refrigeration compressor, having the features of claim 28 and to a refrigeration system having the features of claim 33.

A large number of devices for separating a liquid phase, in particular a lubricating medium, from a mixture having a gaseous phase, in particular a refrigerant, of at least one medium are known from the prior art. Such devices can be used, for example, in refrigeration systems to reduce a proportion of a lubricating medium from the mixture having a refrigerant in a refrigerant circuit of a refrigeration system downstream of a compressor.

Separator devices in different designs that are based on different separation principles have proven successful in the past. So-called mass separators, which separate the second medium using wire mesh or coalescence, for example, are a common design.

Devices for separation with a mass separator force a mixture of the liquid phase and the gaseous phase of at least one medium through a wire mesh. The component of the at least one medium in the liquid phase adheres to the wire mesh. Larger drops form which, due to gravity, can drain downwards through an outlet into a sump, also called an oil sump, while the gaseous medium flows out again at the end of the wire mesh with a reduced proportion of the at least one medium in the liquid phase.

Such a mass separator is known, for example, from DE 19 845 993 A1 and has proven effective in the past. However, there are several disadvantages worth mentioning. Mass separators require a relatively large installation space so that the mixture is sufficiently slowed down and there are low flow velocities. Large flow cross sections are therefore necessary in order to prevent liquid components of the at least one medium from being pushed through the wire mesh and being entrained by the gaseous component of the at least one medium.

Large operating ranges also challenge such separator devices, with considerable effort being needed to maintain a predetermined maximum proportion of the liquid component of the at least one medium in the gaseous component of the at least one medium over the entire operating range. The housing accommodating the mass separator is subjected to high pressure and therefore has to be solid, which leads to a considerable weight and is costly.

Another design known from the prior art is cyclone separator devices. Cyclone separator devices are so-called centrifugal separators and, using centrifugal forces, usually separate the liquid medium from the gaseous medium by means of a rotating flow and have the advantage that a reliable design is possible with the aid of design rules and that a higher degree of separation with a comparatively small installation space can be achieved. Cyclone separator devices typically use a counterflow cyclone principle, according to which the mixture of the liquid and gaseous components undergoes a change in direction. Such cyclone separator devices are also called counterflow cyclone separator devices. The inlet of such a separator device is located in an upper end region of a cyclone chamber and the two-phase mixture flows on an outer diameter in an outer vortex toward a lower end region. A reversal of direction then takes place in the lower end region and the mixture flows back toward the upper end region with a steadily decreasing proportion of the liquid component of the at least one medium within the inner vortex and leaves the cyclone chamber at said upper region via a first outlet. The separated liquid component flows out in the lower end region of the cyclone chamber.

The disadvantage of such counterflow cyclone separator devices is that they require approximately the same amount of installation space as the separator devices with wire mesh mentioned previously. Due to the flow reversal, additional eddies with pressure losses can form, and an already separated component of the liquid phase of at least one medium can be entrained again. Ceiling or short-circuit flows can also form.

Furthermore, direct-flow cyclone separator devices are known from the prior art, in which the at least one two-phase mixture is fed with a swirl into a first end region of a horizontally arranged cyclone chamber. On the opposite side in the cyclone chamber, the gaseous component leaves the cyclone chamber in the second end region with reduced solid and/or liquid component of the at least one medium. Due to the centrifugal forces, the liquid and/or solid component settles on the wall of the cyclone chamber and can flow away via a horizontally arranged second drain. For example, such a device is known from U.S. Pat. No. 10,825,590 B2.

A disadvantage of these direct-flow cyclone separator devices is that a degree of separation or the remaining portion of the liquid and/or solid component of the at least one medium is strongly dependent on the thermodynamic state of the compressor. The main reason for the unsatisfactory part-load behavior is that the rotation speed of the cyclone decreases as the volume flow decreases, which means that the separation efficiency decreases with the volume flow. Another disadvantage of this design is insufficient utilization of installation space.

This is where the present invention comes into play.

Based on this prior art, the object of the present invention is that of providing an improved separator device which expediently does not have the disadvantages known from the prior art. The separator device should use the available installation space efficiently and, in addition, have a high separation efficiency over large operating ranges.

These objects are achieved by a separator device having the features of claim 1, by a compressor, in particular a refrigeration compressor, having the features of claim 28 and by a refrigeration system having the features of claim 33.

Further advantageous embodiments are specified in the dependent claims.

The separator device according to the invention, in particular the lubricating-medium separator device according to the invention, having the features of claim 1, for separating a liquid phase from a mixture having a gaseous phase of at least one medium, has a housing which forms a cyclone chamber, is arranged along a substantially vertically oriented central axis and has an upper end region and a lower end region on opposite sides with respect to the central axis. In addition, the separator device according to the invention has an immersion tube and flow guiding means for forming a cyclone in the cyclone chamber around the central axis, wherein provided in the upper end region of the housing is an inlet into the cyclone chamber for the, in particular two-phase, mixture and provided in the lower end region of the housing is a first outlet for the liquid phase of the at least one medium and a second outlet for the liquid phase, separated from the mixture, of the at least one medium. Furthermore, the immersion tube projects from the lower end region, oriented in the central axis, into the cyclone chamber and is connected to the first outlet, and a sink is formed between the housing and the immersion tube, the sink being located in the lower end region of the cyclone chamber and the separated at least one medium in the liquid phase being able to flow out of the sink, in particular via a sink bottom of the sink, into the second outlet.

The sink is a circumferential, upwardly open space that surrounds the immersion tube. The sink is preferably annular and/or located coaxially with the immersion tube. Both the first outlet and the second outlet are preferably guided through the base of the housing in the lower end region. Further preferably, the first outlet and the second outlet are oriented parallel to the central axis and arranged separately from one another in the lower end region of the housing, in particular in the base. The first outlet can comprise an outlet line through which the component of the at least one medium in the gaseous phase can be discharged for further use with a reduced proportion of the at least one medium in the liquid phase. The main flow directions in the sink and/or in the immersion tube are preferably substantially parallel to the central axis.

The central axis is, especially when used as intended, substantially vertically oriented, with this orientation of the central axis being understood here and in the following to mean an orientation of ±20°, more preferably ±15°, even more preferably ±10°, and most preferably ±5° in relation to the force vector of gravity. The upper end region thus lies, in the central axis, above the lower end region and has a higher altitude than the lower end region. In the context of this invention, radial is understood to mean a straight line direction, starting from the central axis.

The present invention is based on the concept of proposing a separator device which enables a compact design, weight reduction, and cost reduction and has a high separation efficiency even in the partial load range, for example at a nominal mass flow of approximately 25% of the design mass flow. By orienting the central axis substantially vertically, a high separation efficiency can be achieved, especially in the partial load range. A drop formation of the at least one medium in the liquid phase can take place on an inner wall of the housing, the drops being able to run off the housing into the sink due to gravity, without particles being entrained again by the at least one medium in the gaseous phase to the immersion tube and to the first outlet. In the partial load range, the residence time of the, preferably two-phase, mixture is longer due to low flow velocities in the cyclone chamber, with gravity additionally having a beneficial effect on the particles of the liquid phase of the at least one medium and driving them into the sink. The separator device can also be referred to as a vertical-direct-flow cyclone separator device due to the intended orientation and the working principle.

It should be noted at this point that the two-phase mixture can be a mixture of a medium, for example a refrigerating medium, in particular R134a, which is present in both the liquid and the gaseous state of aggregation. The mixture can also consist of a first medium in a gaseous phase or gaseous state of aggregation and an at least second (other) medium in a phase other than the gaseous phase. The phase other than the gaseous phase can be the liquid and/or solid phase or the liquid and/or solid state of aggregation; in the context of the present invention only the liquid phase or the liquid state of aggregation is written, but this can be understood to mean the liquid and/or solid phase or the liquid and/or solid state of aggregation.

The first medium can be, for example, a refrigerating medium, in particular R134a, and the at least one second medium can be a lubricating medium, for example oil.

According to an advantageous development of the present invention, the cyclone chamber has a circular cross section. The circular cross section of the cyclone chamber favors the flow conditions in the cyclone chamber and contributes to improving the overall efficiency, for example, of a refrigeration system or a compressor having such a separator device due to low pressure losses.

According to a development of the present invention, the flow guiding means are formed by the inlet, the inlet supplying the two-phase mixture of the liquid and gaseous phases of the at least one medium tangentially or at a secant to the cyclone chamber in relation to the central axis. According to this preferred development, the inlet opens into the cyclone chamber in the upper end region, preferably flush against a wall, which makes it possible to dispense with the use of baffles, guide vanes, or the like to generate a swirl with a rotation about the central axis. As a result, an overall length in the central axis of the separator device can be kept as small as possible and a more efficient use of the available installation space can be achieved. It should be noted that it is also possible to provide a plurality of inlets which are preferably symmetrically distributed around the central axis.

In addition, according to a development of the present invention, the inlet can be designed to flow the mixture into the cyclone chamber at a substantially perpendicular orientation to the central axis. For this purpose, the inlet can comprise a supply line. The supply line can specify the direction of the inflowing mixture by means of its orientation, which is substantially perpendicular to the central axis of the cyclone chamber. Thus, in a preferred manner, the mixture of the gaseous and liquid phase of the at least one medium can flow in through the inlet substantially perpendicularly to the central axis and, through the first outlet and the second outlet, the liquid and gaseous components of the at least one medium can flow out separately from one another and parallel to the central axis.

It has also proven to be advantageous if the inlet is substantially rectangular or polygonal in cross section.

According to a preferred development of the present invention, the inlet has means for adjusting a flow cross section. The means for adjusting the flow cross section can be used to adjust the speed of the, in particular two-phase, mixture flowing into the cyclone chamber, whereby in particular a rotational speed of the vortex in the cyclone chamber can be adjusted. This allows an optimal separation efficiency of the liquid component from the gaseous component of the at least one medium to be achieved, preferably depending on the operating point.

For example, the means for adjusting the flow cross section can reduce the flow cross section in the partial load range, i.e., at a low mass flow. It is conceivable that the means for adjusting the flow cross section can be designed as a pivoting flap, a movable throttle, or a lamellar screen. Preferably, a height and/or a width of the inlet can be changed by the means for adjusting the flow cross section, with the means for adjusting the flow cross section further preferably displacing the, in particular two-phase, mixture entering the cyclone chamber in the direction of the upper end region and/or the wall of the cyclone chamber. This prevents unfavorable return flows with secondary eddies and, in addition, prevents disadvantageous pressure losses.

According to a development of the present invention, the cyclone chamber is closed in the upper end region by a chamber ceiling. The inlet can advantageously open flush with the chamber ceiling in the cyclone chamber, as a result of which the incoming mixture is guided both by the inner wall of the housing and by the chamber ceiling when it enters the cyclone chamber.

According to a preferred development of the present invention, the chamber ceiling slopes downward starting from the inlet in the direction of the lower end region, the chamber ceiling particularly preferably sloping downward in a circulating manner around the central axis starting from the inlet in the direction of the lower end region. The chamber ceiling can therefore be designed as a spiral, with the spiral preferably being designed to run approximately once around the central axis, but more preferably not extending over the inlet. The pitch of the spiral preferably corresponds to a height of the inlet, the height being measured with respect to the central axis. The sloping chamber ceiling supports cyclone formation in the cyclone chamber, which means that high separation efficiency can be achieved even in the partial load range.

According to a development of the present invention, a core is provided and the core projects in the central axis from the upper end region, in particular from the chamber ceiling, into the cyclone chamber. The core can preferably be located coaxially with the central axis and more preferably be formed rotationally symmetrically about the central axis. Furthermore, it is preferable for the core to extend in the central axis at least over the height of the inlet. The core can further have a free end which is suspended in the cyclone chamber and is preferably positioned in the central axis between the inlet and spaced apart from the immersion tube. The core is configured to displace the preferably two-phase mixture in the cyclone chamber radially outwards—i.e., from the central axis in the radial direction. This accelerates the cyclone flow, and the particles of the at least one medium in the liquid phase are separated due to the centrifugal forces. In addition, the core reduces the influence of the secondary flows occurring in the entry region or in the cyclone region above the core. In the simplest case, the core can be a rod, in particular a cylindrical rod with a preferably constant cross section.

According to a preferred development of the present invention, the core comprises a head, the head preferably being arranged in the region of the free end. The head has a larger cross-sectional area than the core, as a result of which the cross-section through which flow is possible in the cyclone chamber is locally reduced. This accelerates the, in particular two-phase, mixture of a liquid phase and a gaseous phase of at least one medium, or the cyclone flow, and increases the separation rate of the liquid phase of the at least one medium on account of greater centrifugal forces. The head and the immersion tube are preferably arranged coaxially, in particular in the central axis.

According to a development, the head has a cross-sectional area, the cross-sectional area of the head being larger than a cross-sectional area of the immersion tube. For example, the head and/or the immersion tube can have a rotationally symmetrical cross section. In this case, an outside diameter of the head is larger than an outside diameter of the immersion tube. The cross-sectional area of the head should be dimensioned such that in a projection in the central axis, the head completely covers the free end of the immersion tube.

Furthermore, it has proven to be advantageous if the head comprises a collar. The collar preferably protrudes like an umbrella and even more preferably is inclined toward the lower end region. At the end a drip edge can be formed, from which possibly deposited liquid components of the at least one medium can drip off. The collar is preferably designed in such a way that the dripping at least one medium in the liquid phase cannot fall, enter, or drip into the immersion tube.

According to a preferred development of the present invention, the core is capable of vibration and/or at least partially has a coating capable of vibration. In particular, the core can be caused to vibrate by vibrations of the compressor or refrigeration compressor, the vibrations being intended to prevent the liquid phase of the at least one medium from adhering to the surface. This allows the at least one medium in the liquid phase to be better entrained by the flow in the cyclone chamber.

According to a preferred development of the separator device, the head has an aerodynamic shape, which allows an aerodynamically favorable flow guidance to be achieved. For example, the head can be designed in the shape of a torpedo. Preferably, the free end of the core can be shaped conically or have a tapered shape approximating an ellipse. As a result it is possible to directly influence the flow behavior in the cyclone chamber.

According to a development of the present invention, at least one throttle is arranged in the sink. The at least one throttle is preferably designed as a flange which projects from the immersion tube and/or the housing, preferably in the radial direction, into the sink and reduces the cross section through which the flow passes in the sink. The throttle can reduce the pressure in the sink, which both reduces the pressure in the second outlet and reduces return flows from the sink in the direction of the cyclone chamber or the immersion tube. However, the throttle preferably protrudes from the housing, since the prevailing pressure is highest in the region of the housing, i.e., at the large diameters. The throttle can protrude in a radial direction—based on the central axis—into the sink, which is annular in cross section, between 30% and 95% of a relative channel height. The throttle can be designed to be inclined so that second medium separated in particular on the side facing the upper end region can drain.

Furthermore, it has proven to be advantageous if the immersion tube has at least one immersion tube collar. According to a preferred embodiment, the immersion tube collar protrudes from the immersion tube like an umbrella and inclined in the direction of the lower end region or the sink bottom. A drip edge which is formed at the end deflects and prevents (in the direction of the upper end region) return flows that form on the immersion tube. This prevents medium that has already been separated in the liquid phase from being entrained by the return flow. At the drip edge, the at least one medium in the liquid phase can drip off again in the direction of the sink bottom. According to a preferred development, the immersion tube collar projects in a radial direction into the sink between approximately 5% to 25% of a relative channel height.

According to a development, it has proven to be particularly advantageous if the throttle is arranged in the longitudinal axis between the lower end region and the immersion tube collar. As a result, return flows can be effectively reduced and entrainment or re-entry of second medium that has already been separated can be prevented.

Furthermore, it has proven to be advantageous if the second outlet comprises a collection container. The liquid phase of the at least one medium separated in the cyclone chamber and collected in the sink, in particular for supplying the compressor, can be collected and stored in the collection container and used, for example, to lubricate the compressor. The collection container can be pressure-tight in order to withstand pressurization.

According to a development of the invention, the first outlet comprises second flow guiding means for de-swirling the flow. The second flow guiding means can be designed as a tangential or secant discharge point in the transition between the immersion tube and the outlet line. By means of the second flow guiding means, the dynamic pressure of the strongly rotating flow, in particular in the immersion tube, can be recovered and the flow is axially aligned and de-swirled after the tangential discharge point in the outlet line.

In addition, a bypass can be provided, the bypass connecting the first outlet to the second outlet. The bypass comprises a pressure-tight line which provides communication between the first outlet and the second outlet by bypassing the cyclone chamber. The bypass preferably opens into the outlet line of the first outlet. Preferably 10% or less of the net mass flow of the medium in the gaseous phase is passed through the bypass, thereby avoiding the previously described return flows from the sink. The separated component of the liquid phase of the at least one medium is taken away or sucked out of the second outlet by the resulting flow of the medium in the gaseous phase. The bypass preferably branches off from the collection container. More specifically, the bypass can branch off at an outlet opening from the collection container which is located above a level of the liquid phase of the at least one medium in the collection container. The flow velocity can be decelerated in the collection container and remaining particles of the liquid phase of the at least one medium can be separated. The gaseous component of the at least one medium flows from the collection container or the outlet opening of the collection container via the first bypass to the first outlet or in the outlet line of the first outlet. It has been shown that the first bypass can significantly increase the separation efficiency and thus reduce the proportion of at least one medium in the liquid phase.

According to a development of the separator device, at least one second immersion tube can also be provided, which is arranged in the cyclone chamber within the immersion tube. The at least one second immersion tube is arranged set back in the central axis within the immersion tube. In other words, the immersion tube projects beyond the at least one second immersion tube in the central axis in the direction of the upper end region. The at least one second immersion tube forms, between the immersion tube and the at least one second immersion tube, at least one second sink which can be connected to at least one further outlet. The at least one second immersion tube forms a further separation stage in the immersion tube, as a result of which the separation efficiency can be further increased.

According to a development, the further outlet can be connected to the first outlet via a further bypass. Furthermore, it is possible for the further outlet to comprise a further collection container.

It is noted at this point that any number of separation stages may be provided, with each separation stage comprising an immersion tube, a sink, and a corresponding outlet.

Furthermore, it can be advantageous if at least one drop enlargement apparatus is provided. The at least one drop enlargement apparatus is arranged upstream of the inlet and configured to increase the droplet size of the liquid phase of the at least one medium in the two-phase mixture. The at least one drop enlargement apparatus can be, for example and not as an exhaustive list, a wire mesh, a porous medium, baffle plates, baffle elements, a centrifuge, lamellae, sharp-edged deflections, and/or pipe bends. The drop enlargement apparatus increases the particle size of the at least one medium in the liquid phase before it enters the cyclone chamber, as a result of which the separation of the at least one medium in the liquid phase in the cyclone chamber can be improved.

A further aspect of the present invention relates to a compressor, in particular a refrigeration compressor, having a previously described separator device for separating a liquid phase from a mixture having a gaseous phase of at least one medium. The separator device can either be arranged directly on the compressor or can be operated in a refrigerant circuit of a refrigeration system independently of the compressor. The separator device is preferably located downstream of the compression process.

In addition, it has proven to be advantageous if the compressor is a screw compressor. The screw compressor preferably has two rotors arranged, in a rotor axis, vertically one above the other in one plane, the central axis of the separator device being further preferably parallel and spaced apart from the plane of the rotor axes.

It can be advantageous if the separated liquid phase of the at least one medium, preferably a lubricating medium, is fed to the compressor or returned to the compressor. The compressor can have a sump for the at least one medium in the liquid phase, the sump being formed by the first collection container and/or the second collection container. The first bypass and/or the second bypass can thus establish a connection between the sump of the compressor and the first outlet of the separator device.

According to a development, a pulsation damper is provided. The pulsation damper is preferably arranged between an outlet of the compressor and the separator device. However, the pulsation damper can also be arranged downstream of the separator device.

A further aspect of the present invention relates to a refrigeration system comprising at least one previously described separator device. Furthermore, the refrigeration system can have at least one, preferably at least two heat exchangers and an expansion element. Such refrigeration systems can be used in refrigeration, air conditioning, heat pump, and process cooling systems.

According to a preferred development, the at least one separator device is arranged between the expansion element and the at least one heat exchanger. The at least one separator device is preferably arranged downstream of the expansion element and upstream of the at least one heat exchanger. The at least one separator device thus separates the liquid phase from the gaseous phase of the at least one medium upstream of the heat exchanger acting as an evaporator and the separated liquid phase of the at least one medium is passed on to the heat exchanger acting as an evaporator.

Furthermore, it can be advantageous if the gaseous phase of the at least one medium is guided by the at least one separator device completely or partially past the at least one heat exchanger acting as an evaporator.

It can also be advantageous if the gaseous phase of the at least one medium is wholly or partially emitted from the at least one separator device into the at least one heat exchanger acting as an evaporator, with the gaseous phase of the at least one medium preferably being wholly or partially emitted in a ceiling region of the at least one heat exchanger, as a result of which the drop distribution on heat exchanger tubes in the at least one heat exchanger is not influenced so much.

Furthermore, the refrigeration system can comprise a compressor having a separator device.

Several exemplary embodiments of a separator device according to the invention for separating a liquid phase from a mixture having a gaseous phase of at least one medium are described in detail below with reference to the accompanying drawings, in which:

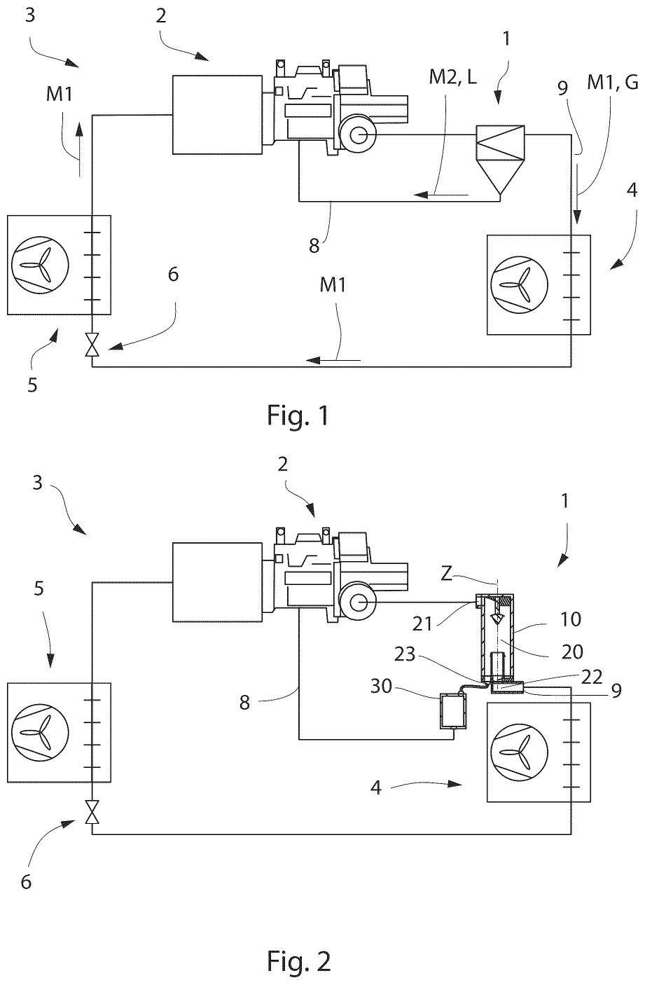

FIG. 1 shows a schematic and greatly simplified first embodiment of a refrigeration system comprising a refrigeration circuit having two heat exchangers, a compressor, a separator device according to the invention, and an expansion element;

FIG. 2 shows the refrigeration system according to FIG. 1, with the separator device being shown in detail;

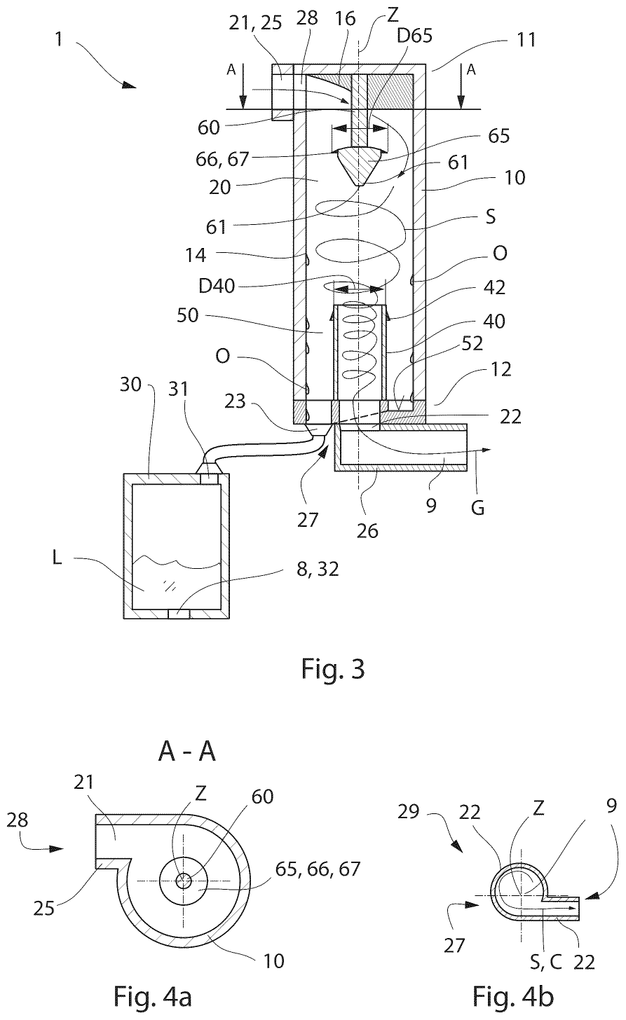

FIG. 3 is an enlarged view of the separator device according to FIG. 2 having a cyclone chamber with an inlet, flow guiding means, and two outlets;

FIG. 4a is a sectional view of the separator device along section line A-A according to FIG. 3;

FIG. 4b is a sectional view of the first outlet of the separator device according to FIG. 3;

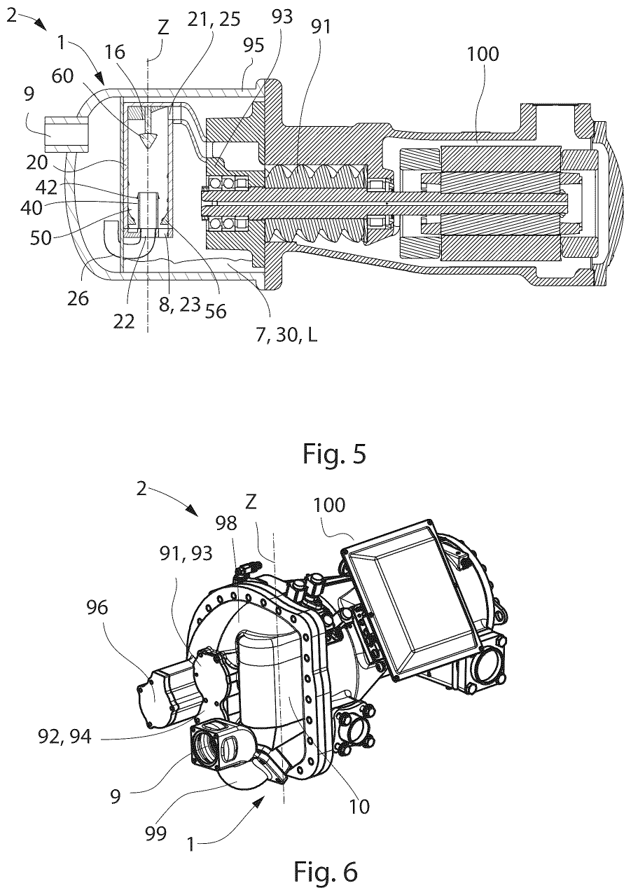

FIG. 5 is a perspective view of the compressor having a separator device according to FIGS. 2 and 3 in a pressure bell of a compressor;

FIG. 6 is a view of the compressor having a separator device according to FIGS. 2 and 3, the separator device being arranged on the compressor housing;

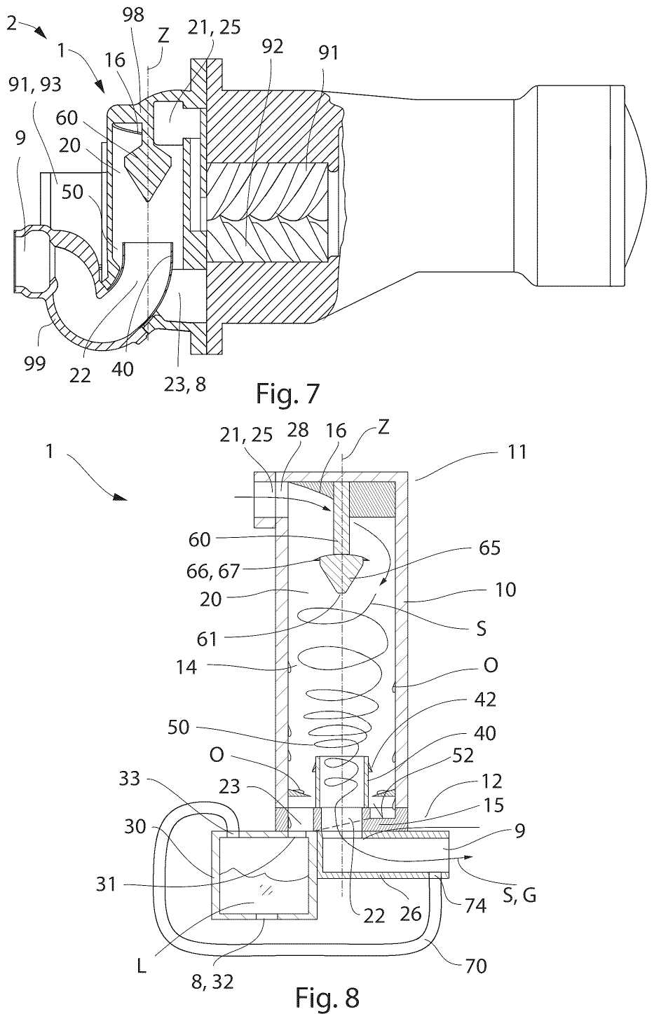

FIG. 7 is a sectional view of the compressor having a separator device according to FIG. 6;

FIG. 8 shows a second exemplary embodiment of the separator device having suction generated by a bypass;

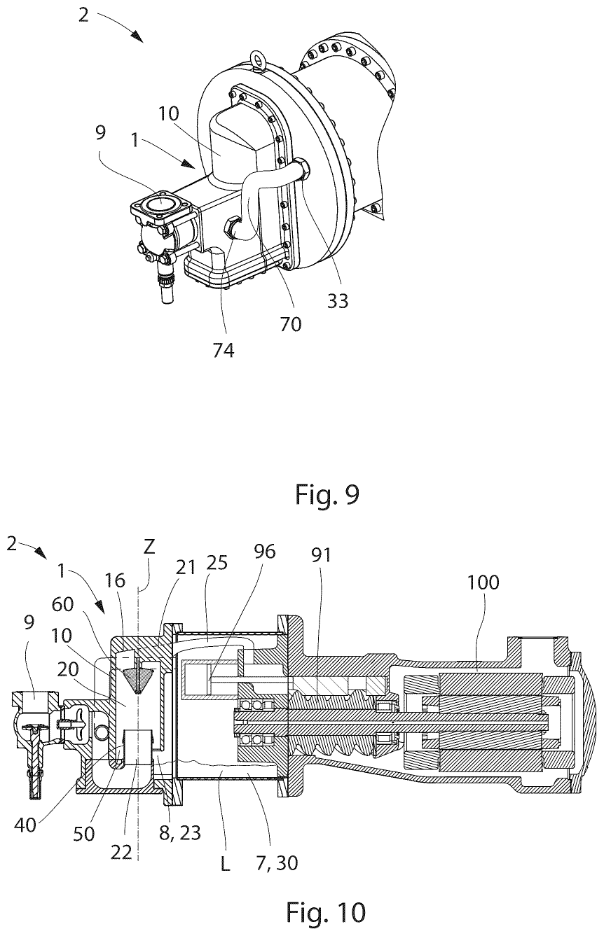

FIG. 9 is a perspective view of the compressor having a separator device according to FIG. 8;

FIG. 10 is a sectional view of the compressor having a separator device according to FIG. 8;

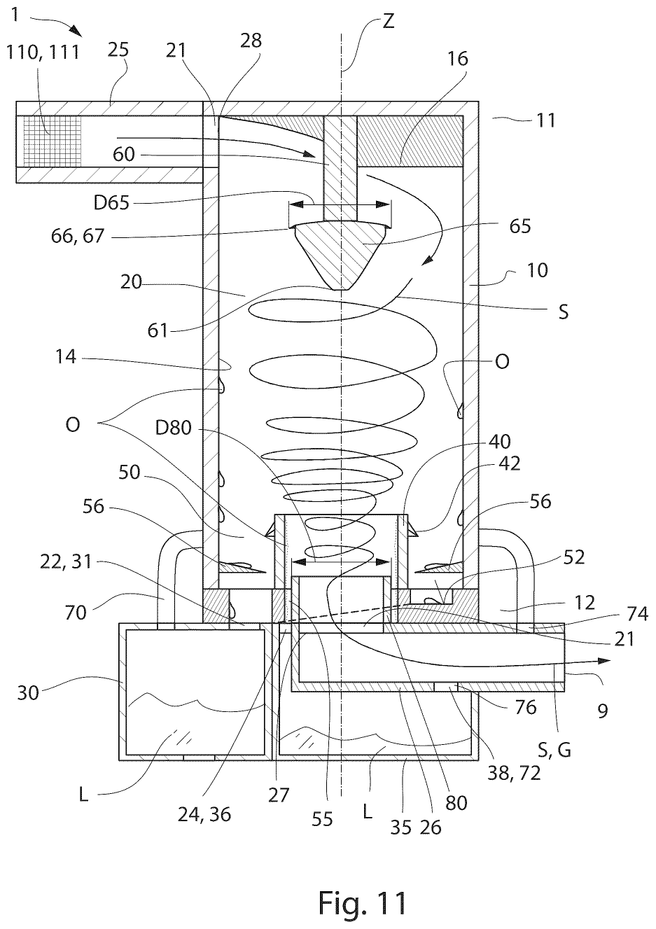

FIG. 11 shows a third exemplary embodiment of the separator device having a second separation stage; and

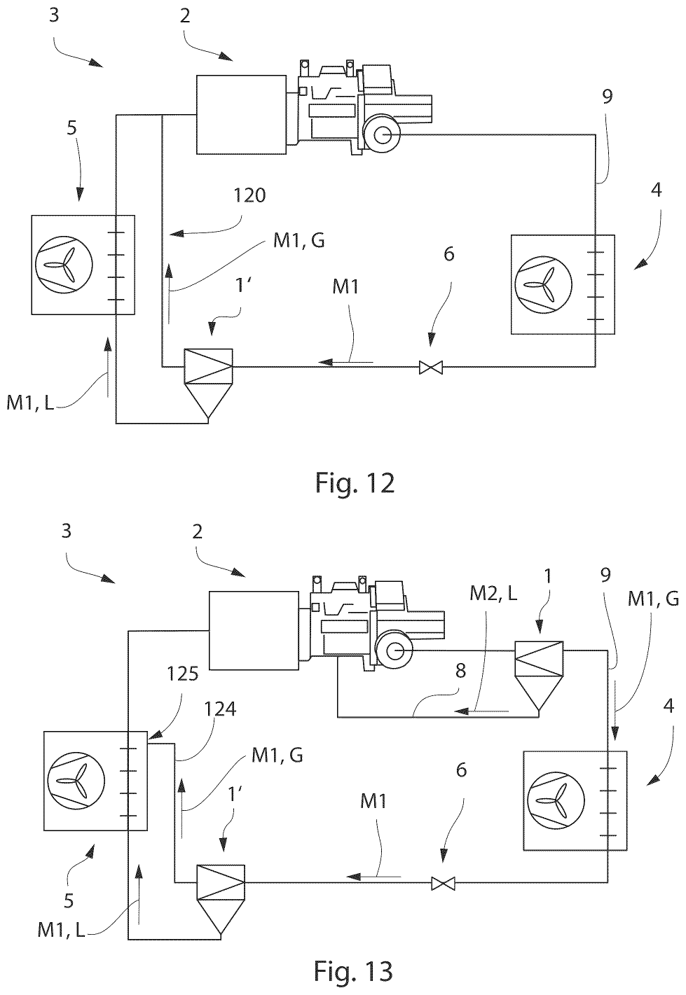

FIG. 12 shows a first development of the refrigeration system according to FIG. 1, the separator device being arranged between the expansion element and a heat exchanger used as an evaporator; and

FIG. 13 shows a second development of the refrigeration system according to FIGS. 1 and 12.

Identical or functionally identical components are identified with the same reference symbols. In addition, not all identical or functionally identical components are provided with a reference number in the Figures.

FIG. 1 shows a refrigeration system, having a refrigeration circuit 3, a compressor designed as a refrigeration compressor 2, a separator device 1, two heat exchangers 4, 5, and an expansion element 6. A mixture of a gaseous phase and a liquid phase of at least one medium M comes from the refrigeration compressor 2 and is first passed to the separator device 1 in order to reduce a proportion of the liquid phase L in the mixture and to separate at least the liquid phase L from the gaseous phase G of the at least one medium M.

The separator device 1 can be used, as explained below, to separate the liquid phase of a second medium M2, for example a lubricating medium, from a mixture having a liquid phase of a first medium M1, for example a refrigerating medium.

For the sake of completeness, it is noted that the first medium M1 and the second medium M2 can be the same medium, but the first medium M1 and the second medium M2 can have different states of aggregation in the mixture. The separator device according to FIGS. 12 and 13, where it is indicated with the reference number 1′ for better understanding, separates the liquid phase L of a medium from a two-phase mixture of the medium having a liquid phase of the medium. The medium there can be, for example, a refrigerating medium, in particular R134a.

For better understanding, the flow directions are indicated in FIGS. 1, 12, 13 using bearing lines.

FIG. 1 shows that the liquid phase L of the second medium M2 is fed to the compressor via a line 8 after separation from the gaseous phase G of the first medium M1. The separator device 1 releases the gaseous phase L of the first medium M1 with a reduced proportion of the liquid phase L of the second medium M2, preferably 0.05% to 0.5%, via a medium outlet 9, from where the gaseous phase G of the first medium M1 is guided to a first heat exchanger 4 and cooled and/or liquefied by heat dissipation. The first medium M1 is then expanded in an expansion element 6 and passed to the second heat exchanger 5—also called an evaporator—it being possible for the heat to be absorbed by the first medium M1 in the second heat exchanger 5.

A schematic and simplified design of an exemplary embodiment of the separator device 1, in particular the lubricant separator device, can be seen from FIGS. 2 and 3.

The separator device 1 for separating the second medium M2 in a liquid phase L from the mixture having the first medium M1 in a gaseous phase G has a housing 10 which forms a cyclone chamber 20 and extends along a central axis Z. The central axis Z corresponds approximately to the line of symmetry of the housing 10 and the cyclone chamber 20 and is oriented substantially vertically as intended, i.e., in the installed position. The housing 10 has an upper end region 11 and a lower end region 12, the end regions 11, 12 lying on opposite sides of the housing 10 in the central axis Z.

The substantially vertical orientation of the central axis Z can be understood to mean a tolerance of ±20°, more preferably ±15°, even more preferably ±10°, and most preferably ±5° with respect to the force vector of gravity. When the separator device 1 is used as intended, the upper end region 11 lies, in the central axis Z, above the lower end region 12 and has a higher altitude than the lower end region 12.

The housing 10 is closed in the upper end region 11 and the lower end region 12, the housing 10 being closed in the upper end region 11 by a chamber ceiling 16 and in the lower end region 12 by a base 15.

The cyclone chamber 20 has an inlet 21, a first outlet 22, and a second outlet 23, it being possible to access the cyclone chamber 20 through the housing 10 via the inlet 21, the first outlet 22, and the second outlet 23. The mixture of the gaseous phase G of the first medium M1 and the liquid phase L of the second medium M2 coming from the refrigeration compressor 2 can be introduced into the cyclone chamber 20 through the inlet 21. The gaseous phase G of the first medium M1 can be discharged through the first outlet 22 and the separated liquid phase L of the second medium M2 can be discharged from the cyclone chamber 20 or the housing 10 through the second outlet 23.

The inlet 21 is arranged in the upper end region 11 and the first outlet 22 and the second outlet 23 are arranged in the lower end region 11. This arrangement of the inlet 21, the first outlet 22, and the second outlet 23 results in a main flow direction in the cyclone chamber 20 from top to bottom, i.e., substantially in the direction of gravity and thus parallel to the central axis Z. The separator device 1 is therefore a direct-flow cyclone separator device.

The separator device 1 also has an immersion tube 40. The immersion tube 40 preferably projects in a free-standing manner into the housing 10 from the lower end region 12 into the cyclone chamber 20, the immersion tube 40 in the cyclone chamber 20 preferably being arranged substantially parallel to the central axis Z. In other words, a free end of the immersion tube 40 is arranged in the central axis Z at a distance from the base 15, the free end preferably lying in a plane perpendicular to the central axis Z.

The immersion tube 40 forms a sink 50 between the housing 10 and the immersion tube 40, the sink 50 being open at the top and delimited or closed at the bottom—i.e., in the lower end region 12—by a sink bottom 52, which can preferably be formed by the base 15 of the housing 10.

The housing 10 and the immersion tube 40 are preferably arranged coaxially and more preferably rotationally symmetrical in cross section. A free end of the immersion tube 40 has an outside diameter D40.

The immersion tube 40 is connected to the first outlet 22 and the sink 50 to the second outlet 23, the separated liquid phase L of the second medium M2 being able to flow into the second outlet 23 via the sink bottom 52 or base 15. As shown in FIGS. 1 and 2, the first outlet 22 and the second outlet 23 are oriented approximately parallel to the central axis Z and lead through the base 15 of the housing 10.

As indicated in FIG. 3 by a dashed line, the sink bottom 52 can have a slope which is oriented toward the second outlet 23 and promotes drainage of the separated liquid phase L of the second medium M2 to the second outlet 23 via the sink bottom 52.

As per FIG. 4b, the first outlet 23 can comprise an outlet line 26, the outlet line 26 being fluidly connected to the immersion tube 40. The outlet line 26 guides the gaseous phase G of the first medium M1 to the refrigerant outlet 9 for further use, in particular in the refrigeration circuit 3 of the refrigeration system.

As per the view in FIG. 4b, second flow guiding means 29 can be provided, by means of which the flow coming from the immersion tube 40 is de-swirled or the helical flow coming from the cyclone chamber 20 is deflected into an axial flow, preferably an as axial a flow as possible. For example, the first outlet 22 can comprise a transition 27 which connects the immersion tube 40 to the outlet line 26, the transition 27 being designed as a tangential or secant discharge point. The dynamic pressure of the strongly rotating flow coming from the immersion tube 40 can be recovered by the second flow guiding means 29. The flow is axially aligned after the tangential discharge point in the outlet line 26.

The second outlet 23 can include a collection container 30. The collection container 30 is preferably a pressure-tight container that can hold the separated liquid phase L of the second medium M2. The separated liquid phase L of the second medium M2 can enter the collection container 30 through a second inlet opening 31 and accumulate on a bottom of the collection container 30. To remove the liquid phase L of the second medium M2, an outlet opening 32 can be provided at a bottom region of the collection container 30, through which, for example, the liquid phase L of the second medium M2 can be returned to the compressor via the line 8.

The inlet 21 is arranged in the upper end region 11 of the housing 10 and preferably opens—as can be seen in FIG. 3—flush with the chamber ceiling 16 in the cyclone chamber 20. Furthermore, flow guiding means 28 are arranged in the upper end region 11, through which the preferably two-phase mixture of the gaseous phase G of the first medium M1 and the liquid phase L of the second medium M2 introduced through the inlet 21 is provided with a swirl to form a cyclone in the cyclone chamber 20 around the central axis Z.

In a preferred embodiment of the separator device 1, the inlet 21 opens into the upper end region 11 in the wall 14, the inlet 21 being arranged offset from the central axis Z in relation to the central axis Z according to FIG. 4a. Accordingly, the inlet 21 is arranged tangentially or at a secant to the cyclone chamber 20 and forms the flow guiding means 28 by means of which the mixture flows through the wall 14 into the cyclone chamber 20 in a swirling manner. The flow guiding means 28 deflect the incoming mixture into a flow path rotating about the Z axis.

The inlet 21 is preferably substantially square or polygonal in cross section and is further preferably configured such that the inflowing mixture flows into the cyclone chamber 20 tangentially and approximately perpendicular to the central axis Z.

Furthermore, with reference to the accompanying FIGS. 2 and 3 it can be seen that the chamber ceiling 16 forms flow guiding means 28. For this purpose, the chamber ceiling 16 of the housing 10 can be designed to be inclined. The chamber ceiling 16 can be designed to slope downward starting from the inlet 21 in the direction of the lower end region 12, with the chamber ceiling 16 even more advantageously being designed, on the side facing the cyclone chamber 20, in the manner of a spiral and sloping downward in a circulating manner around the central axis Z in the direction of the lower end region 12. However, the spiral does not extend completely around the central axis Z, but rather ends in the direction of rotation preferably in front of or flush with the inlet 21. The pitch of the spiral preferably corresponds approximately to a height of the inlet 21. However, the spiral can also be formed by a baffle or an insert in the cyclone chamber 20.

The flow guiding means 28 form a swirl generator which deflects the inflowing mixture so that a helical flow is formed in the cyclone chamber 20 around the central axis Z and moves downward in the direction of gravity.

The separator device 1 can further comprise a core 60, which projects from the upper end region 11 or from the chamber ceiling 16 into the cyclone chamber 20, oriented in the central axis Z. The core 60 is preferably arranged coaxially with the central axis Z and has a free end 61 which is preferably free-standing in the cyclone chamber 20. The free end 61 is arranged below the inlet 21 with respect to the central axis Z and is further preferably positioned between the inlet 21 and the immersion tube 40 or the free end of the immersion tube 40.

The core 60 is preferably rod-shaped and more preferably rotationally symmetrical and can also have a head 65 which can be arranged in the region of the free end 61 of the core 60.

The head 65 has an outside diameter D65 and has a larger cross-sectional area than the core 60. The head 65 can have an aerodynamic shape, which can preferably be described as torpedo-shaped. Accordingly, the head 65 has a converging end on the side facing the lower end region 12, it being possible for the converging end to be either conical or ellipsoid. Furthermore, the head 65 or core 60 can comprise a collar 66, the collar 66 protruding like an umbrella in the radial direction. The head 65 preferably comprises the collar 66, and the collar 66 can be arranged on the side of the head 65 nearest the upper end region 11. Furthermore, the collar 66 forms a drip edge 67 which projects from the rest of the head 65 and projects in an umbrella shape from the core 60 or head 65 and is inclined toward the lower end region 12.

The head 65 and the collar 66 are arranged, in the central axis, between the immersion tube 40 and the inlet 21. The head 65 is preferably arranged below the inlet 21. A distance between the inlet 21 and the head 65—based on the central axis Z—is smaller than a distance between the immersion tube 40 and the head 65.

The cross-sectional area of the head 65 is at least as large as a cross-sectional area of the immersion tube 40; in other words, the following applies: D65≥D40. Consequently, in a projection in the central axis Z, the head 65 completely covers the free end of the immersion tube 40.

The core 60 has the task of displacing, or the core 60 is configured to displace, the mixture in the cyclone chamber 20 from the central axis Z in the radial direction. As a result, the flow velocity in the cyclone can increase and the separation rate of the liquid phase L of the second medium M2 can be increased. Inertial forces carry the second medium M2 in the liquid phase L, which medium is specifically heavier than the first medium M1 in the gaseous phase G, to the wall 14, where the separated liquid phase L of the second medium M2 can drain into the sink 50, as is shown symbolically in FIGS. 3, 8, and 11 using the nose-like liquid elements.

The immersion tube 40 preferably protrudes into the cyclone chamber 20 in the central axis Z by approximately 5-35% of a total height, which describes the distance between the base 15 and the chamber ceiling 16, and can also have, as per FIGS. 3, 8, and 11, an immersion tube collar 42. The immersion tube collar 42 surrounds the immersion tube 40 or preferably completely surrounds the immersion tube 40 in the form of a strip and protrudes from the immersion tube 40 into the sink 50. The immersion tube collar 42 is further preferably inclined toward the lower end region 12 so as to form a drip edge. The immersion tube collar 42 can preferably be arranged in the upper half, more preferably in the last quarter, of the immersion tube 40 within the cyclone chamber 20 in the sink 50 and at a distance from the sink bottom 52. Furthermore, the immersion tube collar 42 preferably projects into the sink 50 by between 5-25% of a relative channel height of the sink 50.

The immersion tube collar 42 is intended to prevent the separated liquid phase L of the second medium M2 from being entrained by return flows in the direction of the upper end region 11 along the immersion tube 40. These return flows are formed due to a pressure difference between the wall 14 and the immersion tube 40, the higher pressure on the wall 14 in the sink 50 being the driving force.

FIGS. 5, 6, and 7 show the compressor according to FIGS. 1 and 2 in different embodiments, the compressor being designed as a refrigeration compressor 2. The separator device 1 is arranged in a pressure bell 95 in the compressor according to FIG. 5 and, on the compressor according to FIGS. 6 and 7, is integrated into a housing cover 98 of the compressor. The separator device 1 is arranged on the compressor in FIGS. 5, 6, and 7 in such a way that the central axis Z is arranged substantially vertically.

The pressure bell 95 can often be found on compressors that have a separator device with wire mesh. To retrofit such compressors, the separator device with wire mesh in the pressure bell 95 can be replaced by a separator device 1, as a result of which the proportion of the liquid phase L of the second medium M2, in particular in the partial load range, in the gaseous phase G of the first medium M1, can be reduced. In this embodiment, the pressure bell 95 absorbs the high pressure; the separator device 1 itself does not have to withstand any particular pressure loads.

The compressor according to FIG. 5 can be a refrigeration compressor, which can be designed as a screw compressor with one rotor 91 or a plurality of rotors 91, 92. The at least one rotor 91, 92 is driven by a drive 100 and transfers the mixture on the pressure side to the separator device 1 via the supply line 25. The pressure bell 95 can be divided into two chambers by a separation, with the separator device 1 being arranged in one of the two chambers. The second chamber can be connected to the first outlet 22 and can also have the refrigerant outlet 9 through which the first medium M1 or the refrigerating medium leaves the compressor.

The second outlet 23 forms the line 8 and opens into a sump 7 of the compressor, which forms or replaces the collection container 30. The compressor uses the sump 7 to lubricate the components, such as the bearings and/or the rotors.

The compressor according to FIGS. 6 and 7 does not have a pressure bell 95. In particular on the basis of the perspective view according to FIG. 6, it can be seen that the separator device 1 is arranged on the housing cover 98 in a plane perpendicular to one of the rotor axes of the rotors 91 or 92 next to the bearing apparatuses 93, 94 of the rotors 91, 92.

The compressor can have one or more rotors 91, 92, which can be arranged as designed. However, it can be advantageous if the rotors 91, 92 are arranged one above the other—as shown. In such an exemplary arrangement, the rotor axes of the rotors 91, 92 lie in a common plane which is arranged in parallel with and spaced apart from the central axis Z of the separator device 1. Furthermore, the compressor can have a slide 96 that can be used for power control.

The housing cover 98 can preferably be a cast part. The housing cover 98 can partially form the separator device 1, for example housing 10 with chamber ceiling 16, inlet 21, second outlet 23, flow guiding means 28, and core 60. The first outlet 22 and the immersion tube 40 can be formed by a housing cover part 99 which can be fastened to the housing cover 98. As FIG. 7 shows, the housing cover part 99 can comprise the refrigerant outlet 9 and can also accommodate a check valve and/or a shut-off valve.

FIG. 8 shows a development of the separator device 1. Compared to the exemplary embodiment already described, the separator device 1 has a suction for the liquid phase L of the second medium M2 and a throttle in the sink 50, it being possible to accomplish the suction by means of a bypass 70 which connects the second outlet 23 to the first outlet 21 by bypassing the cyclone chamber 20. The bypass 70 creates a flow of the gaseous phase G of the first medium M1 through the second outlet 23, by means of which flow the separated liquid phase L of the second medium M2 is entrained or sucked out of the sink 50 or the sink bottom 52.

The second outlet 23 comprises, in analogy to the separator device 1 shown in FIG. 3, a collection container 30 having the inlet opening 31 and an outlet opening 33 for the gaseous phase G of the first medium M1, and an outlet opening 32 for the liquid phase L of the second medium M2. The outlet opening 33 for the gaseous phase G of the first medium M1 is preferably arranged in the collection container 30 in an upper end region such that the outlet opening 33 for the gaseous phase G of the first medium M1 is above a level of the liquid phase L, collected in the collection container 30, of the second medium M2. Furthermore, the distance between the inlet opening 31 and the outlet opening 33 for the first medium M1 in the gaseous phase G should be chosen to be as large as possible in order to increase the residence time of the first medium M1 discharged with the second medium M2 in the liquid phase L through the second outlet 23 in the gaseous phase G in the collection container 30. Furthermore, the volume of the collection container 30 should be selected such that the flow in the collection container 30 is decelerated, whereby further portions of second medium M2 can be separated in the liquid phase L in the collection container 30 and the portion of the second medium M2 in the liquid phase L in the first medium M1 output from the separator device 1 can be further reduced in the gaseous phase G.

The bypass 70 connects the outlet opening 33 for the gaseous phase G of the first medium M1 and the first outlet 22 or the outlet line 26. The bypass 70 preferably opens at an outlet connection 74 into the first outlet 22 outside the housing 10 or into the outlet line 26. Approximately 1-10% of the total mass flow of the first medium M1 preferably flows through the bypass 70.

The throttle 56, which is in particular also shown in detail in FIG. 11, is arranged on the wall 14 of the housing 10 and projects into the sink 50 in the direction of the immersion tube 40. The throttle 56 can be wedge-shaped and, as shown in FIGS. 8 and 11, beveled on the side facing the upper end region 11, as a result of which the liquid phase L of the second medium M2 can drain from the side facing the upper end region. This portion of the second medium M2 in the liquid phase L is indicated by nose-like liquid elements in FIGS. 8 and 11.

The throttle 56 is preferably arranged between the immersion tube collar 42 and the lower end region 12 or the sink bottom 52 and preferably blocks between 25-95% of a relative channel height of the sink 50. The throttle 56 lowers the pressure on the side facing the second outlet 23 in the sink 50, thus considerably reducing the previously described return flows. At the same time, the throttle 56 can be used to adjust the mass flow through the bypass 70. However, it should be noted at this point that the throttle 56 can be used in the proposed separator device 1 independently of the bypass 70.

FIGS. 9 and 10 show, in analogy to FIGS. 5 to 7, the integration of the previously described separator device 1 with a bypass 70 on a compressor, in particular as a retrofit kit. The sump 7 of the compressor is formed by the collection container 30, the sump 7 being connected to the first outlet 22 via the bypass 70. In the case of the compressor, the sump 7 can also be referred to as an oil sump or lubricating-medium sump.

In particular, it can be seen from FIG. 9 that the bypass 70 is formed by a line which bypasses the cyclone chamber 20 or the housing 10 forming the cyclone chamber 20. A direct connection between the collection container 30 and the first outlet 22 or the outlet line 26 can thus be created.

A third and exemplary embodiment of the separator device 1 can be seen in FIG. 11, this third exemplary embodiment of the separator device 1 being designed analogously to the second exemplary embodiment of the separator device 1 according to FIGS. 8-10 and further comprising a second suction, with the result that the proportion of the liquid phase L of the second medium M2 in the output gaseous phase G of the first medium M1 can be further reduced. The second suction is accomplished by a second immersion tube 80, which projects through the base 15 of the housing 10 in the lower end region 12 into the cyclone chamber 20, parallel to the central axis Z.

The second immersion tube 80 is arranged within the immersion tube 40 and preferably coaxially with the immersion tube 40 and is set back in the immersion tube 40, that is, the immersion tube 40 projects beyond the second immersion tube 80 in the central axis Z in the direction of the upper end region 11. The second immersion tube 80 has, at a free end, a diameter D80 which is preferably smaller than the diameter D65 of the head 65. A second sink 55 is formed between the second immersion tube 80 and the immersion tube 40, can be designed analogously to the sink 50 between the immersion tube 40 and the wall 14 of the housing 10 and has a third outlet 24 through which the separated liquid phase L of the second medium M2 can be discharged from the second sink 55 or the cyclone chamber 20.

The third outlet 24 can comprise a further collection container 35, which can be designed analogously to the collection container 30 according to the first and second exemplary embodiment. The collection container 35 can thus have an inlet opening 36 for the liquid phase L of the second medium M2, an outlet opening 37 for the liquid phase L of the second medium M2, and/or an outlet opening 38 for the gaseous phase G of the first medium M1. A second bypass 72 can preferably connect the outlet opening 38 for the gaseous phase G of the first medium M1 to an outlet connection 76 on the first outlet 22 and open there into the first outlet 22 outside the housing 10.

The second bypass 72 can be designed analogously to the bypass 70 and connects the third outlet 24, in particular a gas region of the further collection container 35, to the first outlet 21, thereby forming a second suction.

The second suction enables, by means of the second immersion tube 80, a further reduction in the proportion of the liquid phase L of the second medium M2 in the output gaseous phase G of the first medium M1, since the flow entering the immersion tube 40 is accelerated considerably above the immersion tube 40 due to the cross-sectional taper of the immersion tube 40 with respect to the cyclone chamber 20. The separated liquid phase L of the second medium M2 is shown by dashed lines in FIG. 11 and can adhere to an inner wall of the immersion tube 40 and flow into the second sink 55 for discharge.

The immersion tube 40 is indirectly connected to the first outlet 22 via the second immersion tube 80.

In terms of flow technology, a drop enlargement apparatus 110 is provided upstream of the cyclone chamber 20. The drop enlargement apparatus 110 is intended to cause a drop distribution in the liquid phase L of the at least one medium with tendentially larger drops in the mixture flowing into the cyclone chamber 20 because larger drops can be separated more easily in the cyclone chamber 20. The separation efficiency can be increased by changing the drop size distribution upstream of the inlet 21. In the present exemplary embodiment according to FIG. 11, the drop enlargement apparatus 110 is accomplished by a wire mesh 111, it being possible for the drop enlargement apparatus 110 to also be, for example and not as an exhaustive list, a porous medium, baffle plates, baffle elements, a centrifuge, lamellae, sharp-edged deflections, pipe bends, and/or the like.

FIG. 12 shows developments of the refrigeration system according to FIG. 1. The refrigeration system according to FIGS. 12 and 13 has a refrigeration circuit 3 comprising the compressor designed as a refrigeration compressor 2, two heat exchangers, 4, 5 and the expansion element 6. Furthermore, the refrigeration system has at least one separator device 1, which is arranged between the expansion element 6 and the heat exchanger 5 acting as an evaporator.

The separator device 1 separates a liquid phase L from a mixture having a gaseous phase G of the medium M1, in particular the refrigerating medium of the refrigeration circuit. For better understanding, the separator device 1, which separates the liquid phase L from a mixture having a gaseous phase G of the medium M1, is provided with the reference number “1′” in FIGS. 12 and 13. Otherwise, the separator device 1′ corresponds to the separator device 1 described in connection with FIGS. 1 to 11.

The medium M1 is expanded in the expansion element 6 and a mixture of the gaseous phase G and the liquid phase L of the medium M1 is output.

The separator device 1′ in the refrigeration system according to FIG. 12 or 13 separates the liquid phase L from the gaseous phase G of the medium M1, and the medium M1 already present in the gaseous phase G is directed, in particular from the first outlet 22, by means of an evaporator bypass 120 past the heat exchanger 5 acting as an evaporator and guided to the refrigeration compressor 2.

As can be seen from FIG. 13, the refrigeration system can also have more than one separator device 1, 1′.

The refrigeration system according to FIG. 13 has two separator devices 1, 1′, with the separator device 1 separating a liquid phase L of the second medium M2 from a mixture having a gaseous phase G of the first medium M1. The separator device 1′ is arranged, analogously to FIG. 12, between the expansion element 6 and the heat exchanger 5 acting as an evaporator.

However, in the development according to FIG. 13, in contrast to the first development of the refrigeration system according to FIG. 12, the gaseous phase G of the first medium M1 separated by the separator device 1′ is not directed past the heat exchanger 5 acting as an evaporator. The gaseous phase G of the first medium M1 is emitted in the heat exchanger 5 acting as an evaporator. By emitting the gaseous phase G of the first medium M1 in the heat exchanger 5 acting as an evaporator, the droplet distribution on the heat exchanger tubes can be influenced. It is particularly preferred if the gaseous phase G of the first medium M1 is emitted via a line 124 through an evaporator ceiling inlet 125 in a ceiling region.

### LIST OF REFERENCE NUMERALS

1 Separator device
2 Refrigeration compressor
3 Refrigeration circuit
4 First heat exchanger
5 Second heat exchanger
6 Expansion element
7 Sump
8 Line
9 Refrigerant outlet
10 Housing
11 Upper end region
12 Lower end region
14 Wall
15 Base
16 Cover
17 Inside
20 Cyclone chamber
21 Inlet
22 First outlet
23 Second outlet
24 Third outlet
25 Supply line
26 Outlet line
27 Transition
28 Flow guiding means
29 Second flow guiding means
30 Collection container
31 Inlet opening of 30
32 Outlet opening of 30 for O
33 Outlet opening of 30 for C
35 Collection container
36 Inlet opening of 35
37 Outlet opening of 35 for O
38 Outlet opening of 35 for C
40 Immersion tube
42 Immersion tube collar
50 Sink
52 Sink bottom
55 Second sink
56 Throttle
60 Core
61 Free end
65 Head
66 Collar
67 Drip edge
70 Bypass
72 Second bypass
74 Outlet connection
80 Second immersion tube
91 Rotor
92 Rotor
93 Bearing apparatuses
94 Bearing apparatuses
95 Pressure bell
96 Slide
98 Housing cover
99 Housing cover part
100 Drive
110 Drop enlargement apparatus
111 Wire mesh
D40 Outside diameter of the immersion tube
D65 Outside diameter of the head
D80 Outside diameter of the second immersion tube
G Gaseous phase
L Liquid phase
M Medium
M1 First medium
M2 Second medium
S Flow path
Z Central axis

1. A separator device (1), in particular a lubricating-medium separator device, for separating a liquid phase (L) from a mixture having a gaseous phase (G) of at least one medium (M), comprising
a housing (10) which forms a cyclone chamber (20), is arranged along a central axis (Z), and has an upper end region (11) and a lower end region (12) on opposite sides with respect to the central axis (Z),
an immersion tube (40), and
flow guiding means (28) for forming a helical flow in the cyclone chamber (20) around the central axis (Z),
wherein provided in the upper end region (11) is an inlet (21) into the cyclone chamber (20) for the mixture and provided in the lower end region (12) is a first outlet (22) for the gaseous phase (G) of the at least one medium (M) and a second outlet (23) for the separated liquid phase (L) of the at least one medium (M),
wherein the immersion tube (40) projects from the lower end region (12) in the central axis (Z) into the cyclone chamber (20) and is fluidly connected to the first outlet (22) and forms a first sink (50) between the housing (10) and the immersion tube (40), and
wherein the separated liquid phase (L) of the at least one medium (M) can flow out of the first sink (50) in the lower end region (22) through the second outlet (23).

2. The separator device (1) according to claim 1, characterized in that the cyclone chamber (20) has a circular cross section.

3. The separator device (1) according to claim 1, characterized in that the flow guiding means (28) are formed by the inlet (21), and in that the inlet (21) is arranged tangentially or at a secant to the cyclone chamber (20) in relation to the central axis (Z).

4. The separator device (1) according to claim 1, characterized in that the inlet (21) flows the mixture into the cyclone chamber (20) at a substantially perpendicular orientation to the central axis (Z).

5. The separator device (1) according to claim 1, characterized in that the inlet (21) is substantially polygonal or rectangular in cross section.

6. The separator device (1) according to claim 1, characterized in that the inlet (21) has means for adjusting a flow cross section.

7. The separator device (1) according to claim 1, characterized in that in the upper end region (11) the cyclone chamber (20) is closed by a chamber ceiling (16).

8. The separator device (1) according to claim 1, characterized in that the inlet (21) opens flush with the chamber ceiling (16) and/or with an outer wall (14) in the cyclone chamber (20).

9. The separator device (1) according to claim 1, characterized in that the chamber ceiling (16) slopes downward starting from the inlet (21) in the direction of the lower end region (12), in particular in that the chamber ceiling (16) slopes downward in a circulating manner around the central axis (Z) starting from the inlet (21) in the direction of the lower end region (12).

10. The separator device (1) according to claim 1, characterized in that a core (60) projects parallel to the central axis (Z) from the upper end region (11) into the cyclone chamber (20).

11. The separator device (1) according to claim 10, characterized in that the core (60) comprises a head (65), and in that the head (65) is arranged, in relation to the central axis (Z), on the side of the inlet (21) facing the lower end region (12).

12. The separator device (1) according to claim 11, characterized in that a cross-sectional area of the head (65) is larger than a cross-sectional area of the immersion tube (40) which is connected to the first outlet (22).

13. The separator device (1) according to claim 10, characterized in that the core (60) comprises at least one collar (66) having a drip edge (67).

14. The separator device (1) according to claim 10, characterized in that the core (60) is capable of vibration and/or at least partially has a coating capable of vibration.

15. The separator device (1) according to claim 10, characterized in that the free end (61) of the core (60) is conical or has a tapering shape approximating an ellipse.

16. The separator device (1) according to claim 1, characterized in that at least one throttle (56) is arranged in the sink (50).

17. The separator device (1) according to claim 1, characterized in that the throttle (56) projects from the immersion tube (40) and/or from the housing (10) into the sink (50).

18. The separator device (1) according to claim 1, characterized in that the immersion tube (40) has at least one immersion tube collar (42).

19. The separator device (1) according to claim 18, characterized in that the immersion tube collar (42) has a drip edge which projects in the shape of an umbrella.

20. The separator device (1) according to claim 18, characterized in that the throttle (56) is arranged in the longitudinal axis (Z) between the lower end region (12) and the immersion tube collar (42).

21. The separator device (1) according to claim 1, characterized in that the second outlet (23) opens into a collection container (30).

22. The separator device (1) according to claim 1, characterized in that the first outlet (22) comprises second flow guiding means (29) for axially orienting the helical flow coming from the cyclone chamber (20).

23. The separator device (1) according to claim 1, characterized in that a bypass (70) is provided which connects the second outlet (22) to the first outlet (21).

24. The separator device (1) according to claim 1, characterized in that at least one second immersion tube (80) is provided, in that at least one second sink (55) is formed between the immersion tube (40) and the at least one second immersion tube (80), and in that the at least one second sink (55) is connected to at least one further outlet (24).

25. The separator device (1) according to claim 1, characterized in that at least one second bypass (72) is provided, which connects the at least one further outlet (24) to the first outlet (21).

26. The separator device (1) according to claim 1, characterized in that at least one drop enlargement apparatus (110) is provided.

27. The separator device (1) according to claim 1, characterized in that the at least one medium (M) is a first medium (M1), preferably a refrigerating medium, in particular R134a, and/or a second medium (M2), preferably a lubricating medium, in particular oil.

28. A compressor, in particular a refrigeration compressor (2), comprising a separator device (1) according to claim 1.

29. The compressor according to claim 28, characterized in that a second sump (18) is provided, in particular in a compressor housing of the compressor, and in that the second sump (18) is connected to the second outlet (23) and/or the third outlet (24) of the separator device (1).

30. The compressor according to claim 28, characterized in that the compressor is a screw compressor having two rotors (91, 92), the two rotors (91, 92) each being arranged in a rotor axis, the rotor axes lying in a plane which is substantially parallel to and spaced apart from the central axis (Z) of the separator device (1).

31. The compressor according to claim 28, characterized in that the first bypass (70) connects the second sump (18) of the compressor to the first outlet (21) of the separator device (1).

32. The compressor according to claim 28, characterized in that a pulsation damper is provided.

33. A refrigeration system comprising at least one separator device (1) according to claim 1.

34. A refrigeration system according to claim 33, characterized in that at least one expansion element (6) and at least one heat exchanger (4, 5) are provided, and in that the at least one separator device (1) is arranged between the expansion element (6) and the at least one heat exchanger (4, 5).

35. A refrigeration system according to claim 34, characterized in that the at least one separator device (1), by means of an evaporator bypass (120), directs the gaseous phase (G) of the at least one medium past the at least one heat exchanger (4, 5), which acts as an evaporator.

36. The refrigeration system according to claim 34, characterized in that the gaseous phase (G) of the at least one medium is emitted from the at least one separator device (1) into the at least one heat exchanger (4,5), which acts as an evaporator.

37. The refrigeration system according to claim 33, characterized in that a compressor, is provided.
